(19) United States
(12) Patent Application Publication
(10) Pub. No.: US 2016/0246051 A1
(43) Pub. Date: Aug. 25, 2016

(54) LENS COVER FOR A PROJECTOR

(71) Applicant: NEC Display Solutions, Ltd., Tokyo (JP)

(72) Inventors: Takayuki Okamoto, Tokyo (JP); Yoshinobu Moriya, Tokyo (JP); Yasuhiro Kitano, Tokyo (JP)

(21) Appl. No.: 15/033,077

(22) PCT Filed: Nov. 5, 2013
(86) PCT No.: PCT/JP2013/079886

§ 371 Date: Apr. 28, 2016

(51) Int. Cl. G02B 27/00; G02B 19/00; G03B 21/14

(52) U.S. Cl. CPC G02B 27/0006; G03B 21/145; G02B 19/0009

(57) ABSTRACT

The objective of the present invention is to provide a lens cover for a projector that prevents the entry of projection light into the user's field of view. This lens cover for a projector has: a first surface that faces a projection lens and into which projection light from the projection lens is irradiated; a second surface that emits the projection light that was irradiated into the first surface; and a refracting part that is provided on the first surface or the second surface or on both surfaces; that is made up of a plurality of recessed parts, and that refracts the projection light in one direction. The lens cover is formed from a material having transparency.

### TECHNICAL FIELD

The present invention relates to a lens cover for a projector.

### BACKGROUND ART

A portion of a projection lens that is used for a projector is exposed from the case. A lens cover that is slidable or detachable from the projector is therefore generally provided with the object of preventing the projection lens from becoming dirty.

On the other hand, lamps that are used in projectors are usually high-luminance, and further, are not frequently turned on and off because many of these lamps need time to start up or go out. As a result, the above-described lens cover is also used, for example, when the projection operation of the projector is to be temporarily interrupted, in which case the lens cover is closed to block the projection light.

Conventionally, a lens cover is made from a material having nontransparency in order that projection light does not leak from the lens cover when projection light is projected with the lens cover not opened. In addition, when projection light is projected with the lens cover closed, the projection light from the projection lens heats and potentially deforms the lens cover, and a material having thermal resistance was therefore selected.

With the continued trend to higher luminance of projectors in recent years, however, the heat resistance required of a lens cover can no longer be met by merely using a material having thermal resistance. As one response to this problem, a switch is provided in the projector to detect the operation when the projection lens is covered by the lens cover, and when the lens cover covers the projection lens, an overheating countermeasure process is implemented such as setting a picture mute state such that the projection light from the projection lens goes out or an aluminum tape is adhered to the rear surface of the lens cover.

In the case of the above-described thermal resistance methods, however, adding to the structure of a projector or increasing the functions requires the use of additional parts and this results in increased costs. In Patent Document 1, a construction is adopted in which a lens cover is constructed from material having transparency such that projection light passes through the lens cover, and although projection light is emitted from the lens cover, the lens cover is not heated by the projection light.

In Patent Document 1, moreover, an uneven surface is formed on the surface of the lens cover on the side that faces the projection lens, this uneven surface satisfying the condition that α is greater than 90°−sin⁻¹(1/n2)−θ2 where α is one half of the vertex angle, n2 is the refractive index of the material of the lens cover, and θ2 is the angle of refraction of light that is perpendicularly incident to the lens cover. The uneven surface of a lens cover of this form does not totally reflect projection light from the projection lens, and as a result, the projection light easily passes through the lens cover and heating of the lens cover is further reduced.

### LITERATURE OF THE PRIOR ART

### Patent Documents

Patent Document 1: Japanese Unexamined Patent Application Publication No. 2008-102368

### SUMMARY OF THE INVENTION

### Problem to be Solved by the Invention

The lens cover of Patent Document 1 allows the passage of projection light from the projection lens and thus does not completely block the projection light even when the lens is covered by the lens cover. As a result, even when the lens cover covers the projection lens, the escaping projection light enters the user's field of view and is therefore annoying and interferes with normal vision.

It is an object of the present invention to provide a lens cover for a projector that keeps projection light from entering the user's field of view.

### Means for Solving the Problem

The lens cover for a projector of the present invention includes: a first surface that faces a projection lens and into which projection light from the projection lens is irradiated; a second surface that emits the projection light that was irradiated to the first surface; and a refracting part that is provided on the first surface or the second surface or on both surfaces; that is made up of a plurality of recessed parts, and that refracts projection light toward one direction. The lens cover is formed from a material having transparency.

### BRIEF DESCRIPTION OF THE DRAWINGS

FIG. 1A is an outer perspective view of a projector that is equipped with a lens cover and shows the state in which the lens cover does not cover the projection lens.

FIG. 1B is an outer perspective view of a projector that is equipped with a lens cover and shows a state in which the lens cover covers the projection lens.

FIG. 1C is a front view of the projector of FIG. 1B.

FIG. 2 is a schematic view of a section taken along line AA of FIG. 1C.

FIG. 3 is an enlarged schematic view of portion B of FIG. 2.

### BEST MODE FOR CARRYING OUT THE INVENTION

The lens cover for a projector of the present invention is next described with reference to the accompanying drawings.

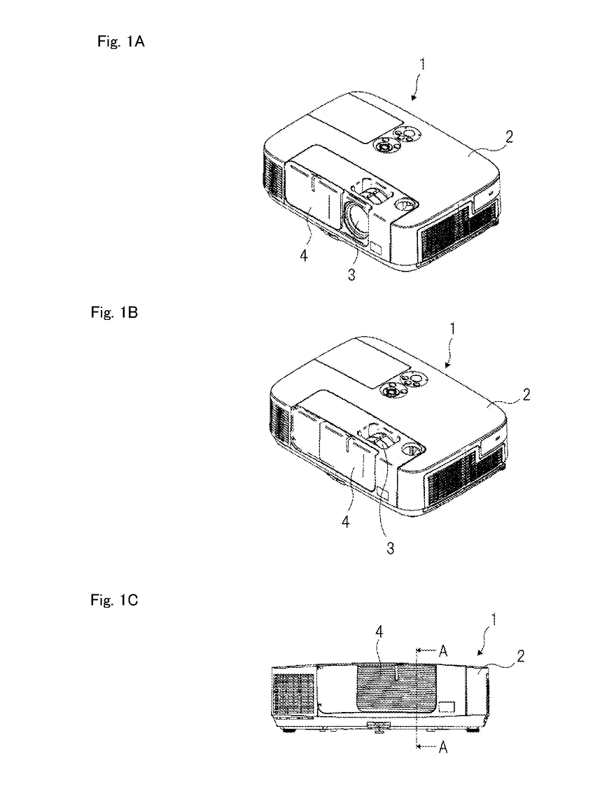

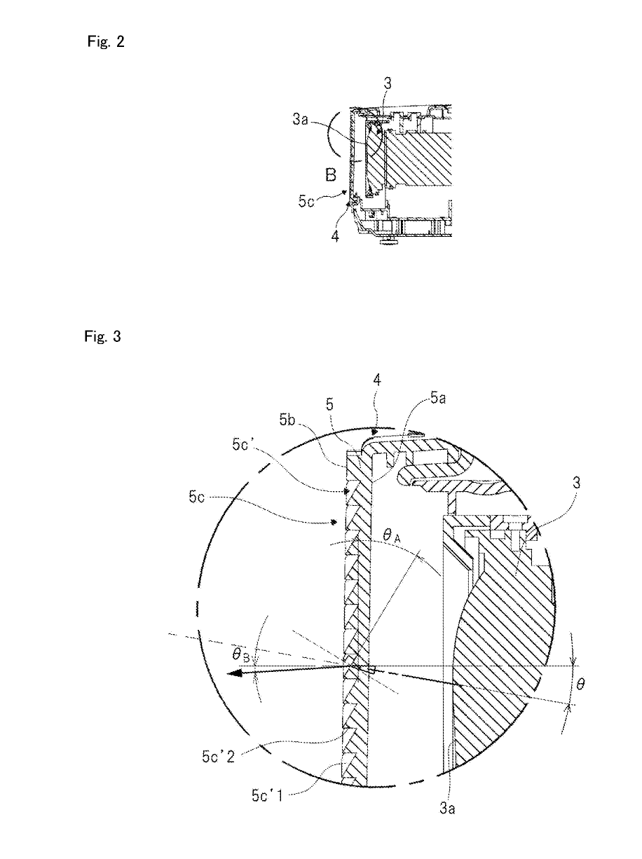

FIG. 1A is an outer perspective view of a projector that is equipped with a lens cover and shows the state in which the lens cover does not cover the projection lens. FIG. 1B is an outer perspective view of a projector that is equipped with a lens cover and shows the state in which the lens cover covers the projection lens. FIG. 1C is a front view of the projector of FIG. 1B. FIG. 2 is a schematic view of a section taken along line AA of FIG. 1C. FIG. 3 is an enlarged schematic view of portion B of FIG. 2.

Projector 1 has case 2, and inside case 2 and is provided with, for example, a light source, a color wheel, lenses, optical elements (such as a light tunnel), an optical modulation element (such as a Digital Micromirror Device (DMD)), and projection lens 3. In addition, sliding lens cover 4 is provided in case 2. Surface 3a of projection lens 3 on the side from which light is emitted is exposed from case 2.

Light emitted from the light source is time-divided by the color wheel into, for example, blue, red, and green and then irradiated into a light tunnel. The intensity distribution of the light that has been irradiated into the light tunnel is made uniform, emitted from the light tunnel, and then modulated according to display images in the DMD. The light that has been modulated by the DMD is projected onto a screen or wall surface by projection lens 3.

Lens cover 4 slides along guides that are formed in the outer surface of case 2 and is able to cover projection lens 3 or expose projection lens 3. Lens cover 4 is composed of a material having transparency. As a result, projection light passes through lens cover 4 even when light is projected with emission surface 3a of projection lens 3 covered by lens cover 4, and heating of lens cover 4 is thus prevented.

Lens cover 4 has planar unit 5 that faces emission surface 3a of projection lens 3. Surface (first surface) 5a that faces projection lens 3 of planar unit 5 is of a planar shape. On the other hand, refracting part 5c having a saw-tooth shape is formed on surface (second surface) 5b that emits projection light that was irradiated into planar unit 5. Refracting part 5c is formed from at least one recessed part 5c′. These recessed parts 5c′ are of a substantially right triangle form that are directed upward from the bottom of lens cover 4. More specifically, recessed parts 5c′ each include slanted surface 5c′1 that slants from the bottom and toward the top of lens cover 4 from the second surface 5b side to the first surface 5a side, and horizontal surface 5c′2 that extends horizontally to connect with slanted surface 5c′1 at the top of slanted surface 5c′1.

In the present invention, slanted surfaces 5c′1 are formed on lens cover 4. As a result, the optical axis of projection light from projection lens 3 is not orthogonal to slanted surface 5c′1. Accordingly, projection light does not advance in a straight line when emitted from lens cover 4 but is refracted downward in the vertical direction of lens cover 4 from the optical axis of projection light from projection lens 3. As a result, in the case of projector 1 that is set up on the floor, when projection light from projection lens 3 is cast upon, for example, a screen, covering projection lens 3 by lens cover 4 causes the projection light to be refracted downward by slanted surfaces 5c′1 of projection lens 3. Accordingly, even when the user is standing in front of the screen, covering projection lens 3 with lens cover 4 keeps projection light that is emitted from lens cover 4 from entering the user's field of view and allows the user to obtain normal vision.

The angle of refraction of projection light that is emitted from lens cover 4 depends on angle of inclination θ_{A} from the vertical direction of slanted surface 5c′1. When set up on the floor, and when θ_{B} is the angle formed by the horizontal direction and the optical axis of projection light emitted from lens cover 4, θ is the up-cast angle of the projector (the angle formed by the horizontal direction and the optical axis of projection light that is projected from projection lens 3), n_{A} is the index of refraction, and n_{B}=1 is the index of refraction of air, these factors can be represented by a relational expression as shown below based on Snell's law (the law of refraction).

n_{A} sin(θ_{A}−θ)=n_{B} sin(θ_{A}+θ_{B}) (See FIG. 3)

Assuming here that the angle of inclination θ_{A} from the vertical direction of slanted surface 5c′1 is 31°, the index of refraction of lens cover 4 is 1.585, which is the index of refraction of polycarbonate, and the up-cast angle θ of the projector is 10°, then the angle θ_{B} formed by the horizontal direction and the optical axis of projection light that is emitted from lens cover 4 is 3.6°. In other words, the projection light is emitted from lens cover 4 in a direction below the horizontal direction. Accordingly, by the appropriate adjustment of angle of inclination θ_{A} from the vertical direction of slanted surface 5c′1, the projection light can be emitted from lens cover 4 in a direction below the horizontal direction. As a result, covering projection lens 3 with lens cover 4 impedes the entry of projection light into the user's field of view, allowing the user to view the surrounding area without any sensation of brightness even when in front of the screen on which the projection light is cast.

In the explanation above, refracting part 5c was provided on second surface 5b by continuously forming a plurality of recessed parts 5c′, but the number of recessed parts 5c′ may be one or there may be spaces between adjacent recessed parts 5c′.

In addition, refracting part 5c may be provided in the first surface 5a or second surface 5b or in both first surface 5a and second surface 5b as long as the effect of refracting the projection light from the projection lens downward in the vertical direction of lens cover 4 can be obtained by lens cover 4.

Although a preferable exemplary embodiment of the present invention has been presented and described in detail, it should be understood that the present invention is not limited to the above-described exemplary embodiment and is open to various modifications and amendments that do not depart from the basic concept of the invention.

### EXPLANATION OF REFERENCE NUMBERS

1 projector
2 case
3 projection lens
3a emission surface
4 lens cover
5 planar unit
5a first surface
5b second surface
5c refracting part
5c′ recessed part
5c′1 slanted surface
5c′2 horizontal surface

1. A lens cover for a projector comprising:
a first surface that faces a projection lens and into which projection light from the projection lens is irradiated;
a second surface that emits said projection light that was irradiated into said first surface; and
a refracting part that is provided on said first surface or on said second surface or on both of said surfaces, that is made up of a plurality of recessed parts, and that refracts said projection light in one direction;
wherein said lens cover is formed by a material having transparency.

2. The lens cover for a projector as set forth in claim 1, wherein:
in a vertical-direction section of said lens cover, said recessed part on said second surface forms a slanting surface that is inclined from said second surface side to said first surface side with progression upward from below.

3. The lens cover as set forth in claim 1, wherein said recessed parts are formed continuously in said vertical direction.

4. The lens cover as set forth in claim 2, wherein said recessed parts are formed continuously in said vertical direction.
